(19) United States
(12) Patent Application Publication
(10) Pub. No.: US 2003/0094475 A1
(43) Pub. Date: May 22, 2003

(54) Novelty strand dispenser

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Clyde I. Coughenour, 16607 Sutton Place, Woodbridge, VA, 22191, US

(21) Appl. No.: 09/989,009

(22) Filed: Nov. 21, 2001

(51) Int. Cl. B26F 3/02

(52) U.S. Cl. 225/46; 225/39

(57) ABSTRACT

A novelty dispensing device has a spool or cone for supplying a strand of confection. The strand is dispensed through an aperture in the housing to a stationary severing means. The spool is supported by bearings within the housing and the cone is supported by a cap on the housing. A loose connection with the housing allows a small pivotal movement of the cone that prevents the strand from binding on the cone during dispensing. The severing means is positioned between inwardly tapering protrusions so that the strand can fit into the severing means but fingers cannot.

### BACKGROUND OF THE INVENTION

1. Field of the Invention

A novelty device dispenses strands of gum or candy from a spool or cone through an aperture to a stationary severing means for separating a select length of strand.

2. Description of Related Art

The provision of string, twine, floss, thread, etc., on a spool, that is pulled out of an enclosure, passed through a cutting means and pressed or pulled against a cutting blade to sever a desired length of the string, is old in the art.

D. Rutecki, U.S. Pat. No. 4,412,662, issued Nov. 1, 1983, teaches dispensing various materials from a spool having end flanges using a movable dispensing member that moves around the flange. The dispensing member is provided with an aperture, configured in the cross-sectional profile of the dispensed material and frictionally engages the end flange so that it can be moved around the spool to dispense a desired length of material and bind the material end when the desired length of material has been dispensed. H. Blades et al, U.S. Pat. No. 6,047,712, issued Apr. 11, 2000, teaches dispensing floss from a door over a toothpaste dispenser. The floss is on a spool positioned on a boss and is threaded through a slot past a cutter knife. J. Spencer et al, U.S. Pat. No. 5,156,311, issued Oct. 20, 1992, teaches a dental floss dispenser. The dispenser includes a cover on a housing having a post that supports a spool and includes a guide and cutter accessible by swinging the cover about a hinge. E. Tamez, U.S. Pat. No. 6,189,545, issued Feb. 20, 2001, dispenses floss from a dispenser in the shape of an apple. Different size floss on spools is dispensed from the stem of the apple.

### SUMMARY OF THE INVENTION

A novelty dispenser for strands of candy or gum; having a circular, rectangular or other cross-sectional shape, is wound onto a rotary spool or a stationary tapered cone. The spool or cone can be permanently or removably positioned within a hollow housing formed in the shape of the novelty. One end of the strand is secured onto the spool or cone and the other end is free and is threaded through an aperture in the housing. The strand is pulled through the aperture until a desired length is removed. The strand is then pressed against a severing means, such as a cutting or knife blade, to sever off the desired length of strand.

The hollow housing can be in the shape of a head or arm or leg of a person or that of an animal or inanimate object. The severing means, such as a knife, is preferably positioned between tapered projections so that the strand can be pressed between the projections and across the severing means with the tapered slot formed not being wide enough for a finger to be inserted or otherwise come into contact with the severing means.

The rotary cylindrical spool is preferably held within the housing using spring bearings that support spool axles. A generally horseshoe shaped spring having a small opening between resilient legs permits the axle to be pressed into the spring bearing after which the legs resiliently hold the axle in place and press on the axle to position the spool and prevent free rotation of the spool while allowing the strand to be pulled off of the spool.

The cone is preferably integral with a cap that supports and holds the spool within the housing. The discharge aperture for the strand is placed perpendicularly to locking pins that hold the cap on the housing. By dimensioning the components of the cap and cone to be a little loose on the housing, the cone is free to pivot through a small arc on the housing about the pins. This small amount of pivotal movement prevents the tendency of the strand to bind as it is unwound from the far side of the spool facing away from the aperture.

### BRIEF DESCRIPTION OF THE DRAWINGS

FIG. 1 is a front elevational schematic view of the dispenser showing the internal components.

FIG. 2 is a side elevational schematic view of the dispenser shown in FIG. 1 showing modified internal components.

### DESCRIPTION OF THE PREFERRED EMBODIMENTS

A novelty dispenser 1 dispenses strands from a hollow main housing 2 having a top or upper end 18 and bottom or lower end 9. The novelty depicted is that of a leg. The object depicted can be other parts of a body, such as a head or arm, or can be an animal or inanimate object. For example, a head with a cutter between the teeth or an animal with a cutting blade in the jaws can be used. The strand can be dispersed, for example through the nose, ear or other body cavity. A spool 15 or cone 3 supports the strand 4 that is threaded through an aperture 5. An opening 8 can be used to secure a first end of the strand to the cone or spool. The second free end of the strand passes between projections 6, shown as toes, where a severing means 7, shown as a knife blade, is secured for cutting the strand at a desired length by pressing the strand against the severing means. The severing means 7 can be anything that cuts or pinches the strand into parts. Although shown as a knife blade, a serrated metal or plastic can be used, or even a sharp or serrated area may be integrally molded into the device. The projections 6 taper together inwardly to provide a tapered passage 14. The passage is wide enough to guide the string toward and to pass it over the severing means 7. The positioning of the severing means and width of the tapered passage 14 are such that the fingers of a user cannot fit between the sides of the passage. The severing means is positioned below the upper extent 20 of the projections and above the lower extent 21 of the projections such that the finger cannot contact the severing means from above or below the projections. The severing means 7 is shown essentially midway between the top and bottom of the big toe and is recessed back essentially one-half the inside length of the big toe.

The strand-like element 4 can be a string formed from a confection, such as a licorice or gum, or an elongated hollow member having discreet confections in it, such as a plastic tube having shaped candies or gum in the tube. To prevent free removal of the strand from the dispenser, the size of the aperture 5 can be made small enough, with respect to the diameter or size of the strand, to provide a small frictional resistance. Alternatively, the apertures can be provided with a resilient or friction providing means within the housing if removal is otherwise too easy. The spacing between the projections 6 can be small enough to hold the end of the stand, or the strand can be pressed inwardly to wedge the strand within the back of the tapered slot 14.

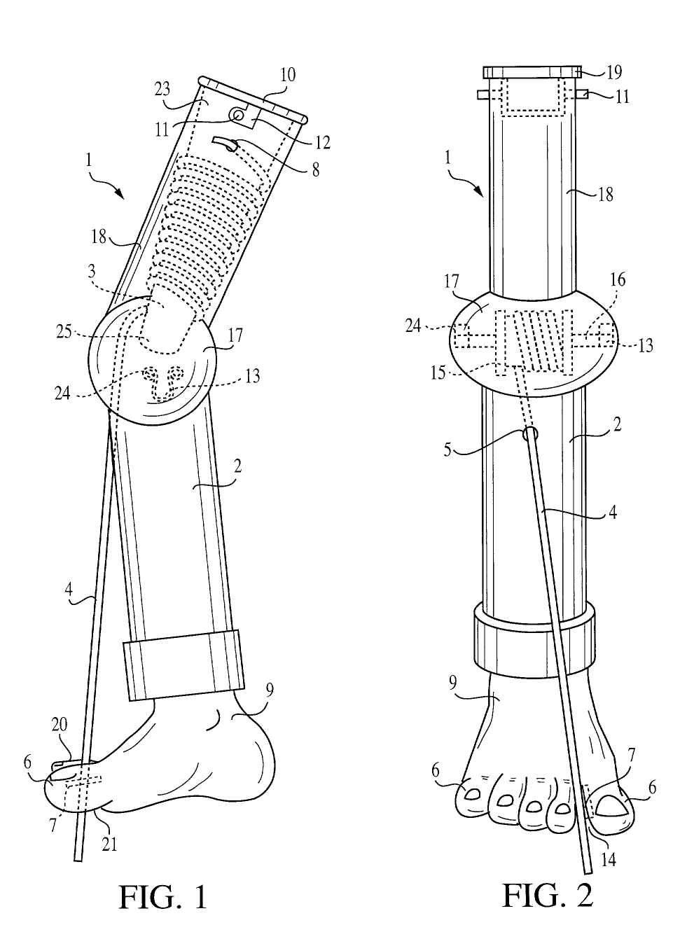

While the general operation of the embodiments shown in both FIGS. 1 and 2 are the same, the storage arrangements are different. In FIG. 1, a non-rotatable cone is used. The cone is preferably an integral part of the cap 10. The cap 10 holds the cone large diameter end 23, on the housing 2 by any convenient means. As shown, pins 11 on the cap, or spool upper end 23 fit within slots 12 to lock the cone 3 onto the housing 2.

To prevent the strand from binding and/or breaking when pulled from the back area of the cone, that side remote from the aperture, the pin 11 and slots 12 are provided with a loose fit so that the spool can pivot a small amount on the pins 11 within the grooves. The small pivotal movement of the spool about the pins allows removal of the strand from the tapered spool without binding. As the strand is pulled toward the aperture from the back, the lower portion of the spool pivots toward the aperture permitting the strand behind the cone to drop down and around the cone lower end 25.

FIG. 2 is shown with a rotatable spool 15. The cap 10, pins 11 and slots 12 are used as an access to the interior of housing 2 but do not have the cone 3 attached. The spool 15 is provided with an axle 16 that is supported in spring bearings 13. The spring bearings are secured in position within a bulb 17 of the housing 2 at their base. The spring bearings have a generally horseshoe shape that can be metallic or plastic. The legs 24 of the spring bearing extend upwardly from the base. The ends extend inwardly toward each other but allow a gap that is smaller than the diameter of the spool axle. The legs provide a frictional force on the axle to prevent free wheeling of the spool and to resist movement of the axle out of and away from its position within the spring bearings.

A new spool can be inserted by removing the cap 10, lifting out the used spool, and pressing a new spool axle into the spring bearings by pressing and passing them between the resilient legs 24. The free end of the strand is preferably threaded through the aperture 5 before positioning the spool within the housing.

The cone 3 can be replenished with strand 4 by removing the cone from the housing 2 and winding a new strand onto the cone or a new previously wound cone 3 can be inserted after threading the strand free end through the aperture 5.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A strand dispensing novelty device consisting of:
an elongated hollow housing having a first upper end and a second lower end;
a strand mounting means held within said elongated housing first end;
a severing means mounted on said elongated housing second end;
an aperture in said hollow housing between said strand mounting means and said severing means for passing said strand from said strand mounting means to said severing means.

2. A strand dispensing novelty device as in claim 1 wherein:
said severing means is placed between projections on said elongated hollow housing second end.

3. A strand dispensing novelty device as in claim 2 wherein:
said projections form an inwardly tapered slot with said severing means secured within said projections along said tapered slot formed by said projections;
said severing means is positioned below the upper extent of said projections and above the lower extent of said projections and said tapered slot is wide enough to allow passage of said strand but narrow enough to prevent a finger from contacting said severing means.

4. A strand dispensing novelty device as in claim 2 wherein:
said severing means is a knife blade.

5. A strand dispensing novelty device as in claim 1 wherein:
said elongated hollow housing first upper end is provided with a cap that provides access to the interior of said elongated hollow housing;
said cap is provided with pins and said elongated hollow housing first upper end is provided with slots;
said cap pins lock said cap on said elongated hollow housing first upper end when placed within said slots.

6. A strand dispensing novelty device as in claim 1 wherein:
said strand mounting means is in the general shape of a cone;
said cone large diameter upper end is attached to a cap that fits on said elongated hollow housing first upper end.

7. A strand dispensing novelty device as in claim 6 wherein:
said cone large diameter upper end has a hole for securing a first end of said strand.

8. A strand dispensing novelty device as in claim 6 wherein:
said cap is provided with pins and said elongated hollow housing first upper end is provided with slots;
said cap pins lock said cap on said elongated hollow housing first upper end when placed within said slots.

9. A strand dispensing novelty device as in claim 8 wherein:
said cone large diameter upper end and said pins fit loose enough on said elongated hollow housing for said cone to pivot a small amount around said pins.

10. A strand dispensing novelty device as in claim 1 wherein:
said severing means is placed between projections on said elongated hollow housing second end;
said projections form an inwardly tapered slot with said severing means within said projections along said tapered slot.

11. A strand dispensing novelty device as in claim 1 wherein:
said severing means is positioned below the upper extent of said projections and above the lower extent of said projections and said tapered slot is wide enough to allow passage of said strand but narrow enough to prevent a finger from contacting said knife blade.

12. A strand dispensing novelty device as in claim 1 wherein:
said strand mounting means is a spool;
said spool is supported within said elongated hollow housing by bearings.

13. A strand dispensing novelty device as in claim 12 wherein:
said bearings are spring bearings that resiliently hold said spool in place.

14. A strand dispensing novelty device as in claim 12 wherein:
said spool has an axle that is placed within said bearings.

15. A strand dispensing novelty device as in claim 14 wherein:
said bearings are spring bearings that resiliently hold said spool in place;
said spring bearings are in the general shape of a horseshoe with upper resilient legs spaced closer together than said spool axle diameter.

16. A strand dispensing novelty device as in claim 12 wherein:
said elongated hollow housing first upper end is provided with a cap that provides access to the interior of said elongated hollow housing;
said cap is provided with pins and said elongated hollow housing first upper end is provided with slots;
said cap pins lock said cap on said elongated hollow housing first upper end when placed within said slots.

17. A strand dispensing novelty device as in claim 16 wherein:
said bearings are spring bearings that resiliently hold said spool in place;
said spring bearings are in the general shape of a horseshoe with upper resilient legs spaced closer together than the diameter of an axle attached to said spool.

18. A strand dispensing novelty device as in claim 15 wherein:
said severing means is placed between projections on said elongated hollow housing second end;
said projections form an inwardly tapered slot with said severing means being a sharp area along said tapered slot;
said sharp area is positioned below the upper extent of said projections and above the lower extent of said projections and said tapered slot is wide enough to allow passage of said strand but narrow enough to prevent a finger from contacting said sharp area.

19. A strand dispensing novelty device as in claim 3 wherein:
said elongated hollow housing is in the general shape of a leg with said projections in the general shape of toes;

20. A strand dispensing novelty device as in claim 19 wherein:
said severing means is positioned essentially midway between the top and bottom of the big toe and back essentially one-half the length of the big toe from the front end of the big toe.
